(19) United States
(12) Patent Application Publication
(10) Pub. No.: US 2020/0153057 A1
(43) Pub. Date: May 14, 2020

(54) BATTERY MODULE WITH CLOSE-PITCH CYLINDRICAL CELLS AND METHOD OF ASSEMBLY

(71) Applicant: Rivian IP Holdings, LLC, Plymouth, MI (US)

(72) Inventors: Nathaniel C. Wynn, Tustin, CA (US); Tyler Collins, Irvine, CA (US); Kyle Butterfield, Rancho Santa Margarita, CA (US)

(21) Appl. No.: 16/680,416

(22) Filed: Nov. 11, 2019

Related U.S. Application Data
(60) Provisional application No. 62/760,853, filed on Nov. 13, 2018.

(51) Int. Cl. H01M 10/643; H01M 4/70

(52) U.S. Cl. CPC H01M 10/643; H01M 4/70

(57) ABSTRACT

A battery module is provided. The battery module comprises a first current collector assembly, a first carrier layer and a first plurality of battery cells. A first terminal of each of the first plurality of battery cells is electrically coupled to a busbar of the first current collector assembly. A first end of each of the first plurality of battery cells is physically coupled to the first carrier layer. The first carrier layer is positioned between the first current collector assembly and the first plurality of battery cells. The battery module comprises a thermal transfer plate and a first thermal interface material thermally and structurally coupling a second end of each of the first plurality of battery cells to the thermal transfer plate. The first thermal interface material maintains the spatial positioning of the second ends of the first plurality of battery cells on the thermal transfer plate during operation.

### CROSS REFERENCE TO RELATED APPLICATION

This disclosure claims the benefit of U.S. Provisional Application No. 62/760,853, filed Nov. 13, 2018, which is hereby incorporated by reference herein in its entirety.

### SUMMARY

Battery cells are often packaged into battery modules that include multiple battery cells and busbars. It is advantageous to package the battery cells closely within the module to provide high energy density in a space-constrained environment. Cylindrical battery cells in a battery module can be positioned with carrier layers at both ends of the battery cells (e.g., top and bottom). The carrier layers may enable efficient assembly of the battery module by providing a positioning structure for the busbars and battery cells in the battery module. Additionally, in the context of “live can” battery cells that have an exposed region of electrically-active casing around the side of the cell, the carrier layers may prevent the battery cells from touching each other and short-circuiting or causing thermal runaway. It is desirable to closely pack battery cells inside a module without having carrier layers limit how closely the battery cells can be packed. It is also desirable to minimize the size and thickness of a carrier layer for space-saving purposes, but the carrier layer may need to be thick enough to handle worst-case tolerance stack-up and effectively prevent the packaged battery cells from touching each other.

In some embodiments, a battery module is provided. The battery module comprises a first current collector assembly, a first carrier layer and at least one battery cell, e.g., a first plurality of battery cells. A first terminal of each of the first plurality of battery cells is electrically coupled to a busbar of the first current collector assembly. A first end of each of the first plurality of battery cells is physically coupled to the first carrier layer. At least a portion of the first carrier layer is positioned between the first current collector assembly and the first plurality of battery cells. The battery module further comprises a thermal transfer plate, e.g., a cold plate, and a first thermal interface material thermally and structurally coupling a second end of each of the first plurality of battery cells to the cold plate. The first thermal interface material maintains the spatial positioning of the second ends of the first plurality of battery cells on the cold plate during operation, e.g., without the use of a separate carrier support structure at the second ends of the first plurality of battery cells.

In some embodiments, the battery module further comprises a second current collector assembly, a second carrier layer, and at least one battery cell, e.g., a second plurality of battery cells. In some embodiments, a first terminal of each of the second plurality of battery cells is electrically coupled to a busbar of the current collector assembly. In some embodiments, a first end of each of the second plurality of battery cells is physically coupled to the second carrier layer. In some embodiments, at least a portion of the second carrier layer is positioned between the second current collector assembly and the second plurality of battery cells. In some embodiments, the battery module further comprises a second thermal interface material thermally and structurally coupling a second end of each of the second plurality of battery cells to an opposite side of the cold plate. In some embodiments, the second thermal interface material maintains the spatial positioning of the second ends of the second plurality of battery cells on the opposite side of the cold plate during operation, e.g., without the use of a separate carrier support structure at the second ends of the second plurality of battery cells.

In some embodiments, the first carrier layer comprises a plurality of recesses. In some embodiments, the first end of each of the first plurality of battery cells is physically coupled to the first carrier layer by being inserted into a respective recess of the plurality of recesses.

In some embodiments, the first carrier layer comprises a translucent material, e.g., a clear plastic material.

In some embodiments, the battery module further comprises a UV-curing adhesive. In some embodiments, the first end of each of the first plurality of battery cells is physically coupled to the first carrier layer with the UV-curing adhesive.

In some embodiments, the first plurality of battery cells is in a close-hex-pack configuration. In some embodiments, each of the first plurality of battery cells is less than approximately 1.5 millimeters apart, e.g., 1.25 millimeters apart.

In some embodiments, the first thermal interface material comprises a tensile strength of at least approximately 5 megapascals. In some embodiments, the first thermal interface material comprises a T-peel strength of at least approximately 7 Newtons per millimeter. In some embodiments, the first thermal interface material comprises a Young's Modulus value of at least approximately 50 megapascals.

In some embodiments, at least one of the first plurality of battery cells comprises an exposed region of electrically-active casing that at least partially covers at least one of the first end and the side of the battery cell.

In some embodiments, the first current collector assembly comprises at least five busbars. In some embodiments, the first plurality of battery cells comprises at least 200 battery cells. In some embodiments, the at least five busbars electrically couple the first plurality of battery cell in parallel and in series.

In some embodiments, a method of assembling a battery module is provided. The method comprises providing a first current collector assembly, a first carrier layer, a first plurality of battery cells, a first thermal interface material, and a thermal transfer plate, e.g., a cold plate. The first carrier layer comprises a first plurality of recesses, each configured to receive an end of a battery cell, e.g., a first end of the battery cell. The method comprises selectively applying an adhesive to each of the first plurality of recesses in the first carrier layer with the first carrier layer in a first position. The method comprises inserting each of the first plurality of battery cells into a respective recess with the first carrier layer in the first position, such that the first end of each of the first plurality of battery cells is coupled to a respective recess of the first carrier layer. The method comprises moving the first carrier layer with the inserted battery cells into a second position, e.g., a position in which the first carrier layer is re-orientated, e.g., turned over, relative to the first position. The method comprises positioning the first current collector assembly adjacent to the first carrier layer. The method comprises, in the second position, electrically coupling each of the first plurality of battery cells to a busbar of the first current collector assembly. The method comprises moving the first plurality of battery cells, the first carrier layer, and the first current collector assembly to the first position. The method comprises applying the first thermal interface material to a second end of each of the first plurality of battery cells. The method comprises coupling the cold plate to the second ends of the first plurality of battery cells with the applied first thermal interface material. The first thermal interface material is configured to maintain the spatial positioning of the second ends of the first plurality of battery cells on the cold plate during operation.

In some embodiments, the method comprises providing a second current collector assembly, a second carrier layer, a second plurality of battery cells, and a second thermal interface material. In some embodiments, the second carrier layer comprises a second plurality of recesses, each configured to receive an end of a battery cell, e.g., a first end of a battery cell. In some embodiments, the method comprises applying an adhesive to each of the second plurality of recesses in the second carrier layer with the second carrier layer in the first position. In some embodiments, the method comprises inserting each of the second plurality of battery cells into a respective recess with the second carrier layer in the first position, such that the first end of each of the second plurality of battery cells is coupled to a respective recess of the second carrier layer. In some embodiments, the method comprises moving the second carrier layer with the inserted battery cells into the second position. In some embodiments, the method comprises positioning the second current collector assembly adjacent to the second carrier layer. In some embodiments, the method comprises, in the second position, electrically coupling each of the second plurality of battery cells to a busbar of the second current collector assembly. In some embodiments, the method comprises moving the second plurality of battery cells, the second carrier layer, and the second current collector assembly into the first position. In some embodiments, the method comprises applying the second thermal interface material to a second end of each of the second plurality of battery cells. In some embodiments, the method comprises coupling an opposite surface of the cold plate to the second ends of the second plurality of battery cells with the applied second thermal interface material. In some embodiments, the second thermal interface material is configured to maintain the spatial positioning of the second ends of the second plurality of battery cells on the cold plate during operation.

In some embodiments, the method comprises providing a pin platform. In some embodiments, the pin platform comprises a generally rectangular form with protruding pins configured to prevent close-packed battery cells from touching each other. In some embodiments, the moving the first carrier layer with the inserted battery cells into the second position comprises applying the pin platform to the second ends of the first plurality of battery cells. In some embodiments, the moving the first carrier layer with the inserted battery cells into the second position comprises moving the first plurality of battery cells, the first carrier layer, and the applied pin platform to the second position.

In some embodiments, moving the first plurality of battery cells, the first carrier layer, and the first current collector assembly to the first position comprises moving the applied pin platform with the first plurality of battery cells, the first carrier layer, and the first current collector assembly to the first position. In some embodiments, moving the first plurality of battery cells, the first carrier layer, and the first current collector assembly to the first position comprises removing the pin platform.

In some embodiments, the first plurality of battery cells is positioned in a close-hex-pack configuration in the first carrier layer. In some embodiments, each of the first plurality of battery cells is less than 1.5 millimeters apart.

In some embodiments, the adhesive applied to each of the first plurality of recesses in the first carrier layer is a UV-curing adhesive. In some embodiments, the method comprises exposing the UV-curing adhesive to a UV light source.

In some embodiments, the method comprises moving the assembled battery module by applying vacuum cups to a plurality of points on the first current collector assembly. In some embodiments, the method comprises moving the assembled battery module by applying an electroadhesive grip to at least a portion of the first current collector assembly. In some embodiments, the method comprises moving the assembled battery module by sealing a surface of the first busbar and maintaining a vacuum in at least one cavity of the first current collector assembly.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a partial end view of an exemplary battery module, in accordance with some embodiments of the present disclosure.

FIG. 2 shows a cross-sectional view of a battery module including a first battery submodule and a second battery submodule, in accordance with some embodiments of the present disclosure.

FIG. 3 shows a partial top view of a group of battery cells packaged in a close hexagonal pack configuration in a carrier layer, in accordance with some embodiments of the present disclosure.

FIG. 4 shows a partial top view of a battery module, in accordance with some embodiments of the present disclosure.

FIG. 5 shows a battery module assembly having a carrier layer in a first orientation, in accordance with some embodiments of the present disclosure.

FIG. 6 shows the battery module assembly of FIG. 5 following insertion of a plurality of battery cells into the recesses of the carrier layer, in accordance with some embodiments of the present disclosure.

FIG. 7 shows the battery module assembly of FIG. 6 after it has been moved from a first orientation shown in FIG. 6 to a second orientation as shown in FIG. 7, in accordance with some embodiments of the present disclosure.

FIG. 8 shows the battery module assembly of FIG. 7 following installation of a current collector assembly, in accordance with some embodiments of the present disclosure.

FIG. 9 shows the battery module assembly of FIG. 8 following moving the battery module from the second orientation back to the first orientation, in accordance with some embodiments of the present disclosure.

FIG. 10 shows the battery module assembly of FIG. 9 following installation of a cooling plate, in accordance with some embodiments of the present disclosure.

FIG. 11 shows a battery module made up of two submodules coupled to opposite sides of a cooling plate, in accordance with some embodiments of the present disclosure.

FIG. 12 shows the battery module of FIG. 11 following the installation of additional battery module elements, in accordance with some embodiments of the present disclosure.

FIG. 13 shows a cross-sectional view of the battery module of FIG. 12, in accordance with some embodiments of the present disclosure.

FIG. 14 shows a partial view of a current collector assembly of a battery module, in accordance with some embodiments of the present disclosure.

FIG. 15 shows a perspective view of a battery module, in accordance with some embodiments of the present disclosure.

FIG. 16 shows a partial top view of a current collector assembly and two battery cells, in accordance with some embodiments of the present disclosure.

### DESCRIPTION

In view of the foregoing, in some embodiments it would be advantageous to provide a battery module with only one carrier layer on one end of the packaged battery cells, thereby saving space on the other end of the packaged battery cells.

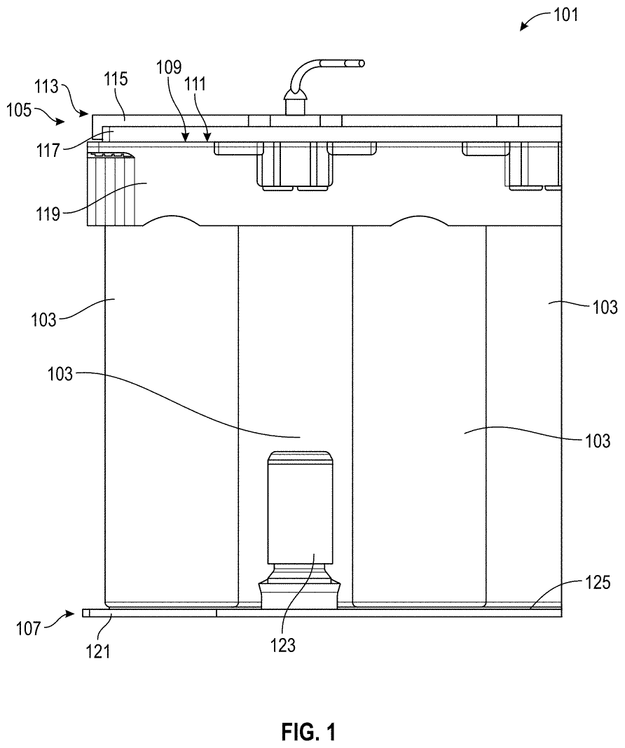

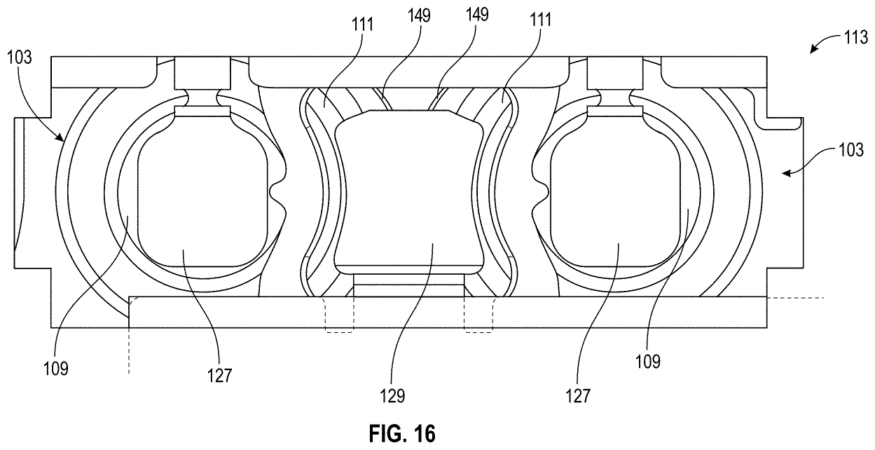

Systems and methods are disclosed herein that provide an improved battery module. The battery module of the present disclosure may provide one or more of the following mechanical advantages: space saving, cost saving, reduced manufacturing and assembly time, and robustness. FIG. 1 shows a partial view of a battery module 101 according to the present disclosure. As shown, the battery module includes a plurality of battery cells 103. The battery cells 103 may be cylindrical and may each have a first end 105 and second end 107, and a first electrical terminal 109 and second electrical terminal 111 (the first and second electrical terminals 109, 111 are more clearly shown in FIG. 16). In some embodiments, each battery cell 103 may have an exposed region of electrically-active casing or a conductive jacket that covers at least a portion of the second end and the side of the battery cell, forming the second electrical terminal. The exposed region of electrically-active casing (or a conductive jacket) may be provided on any appropriate portion of the battery cell 103, depending on the configuration of the battery module 101. As shown, the battery module 101 also includes a current collector assembly 113 that includes a nonconductive layer 115 and at least one busbar 117. The nonconductive layer 115 acts as a structural element to maintain the positioning of conductive busbars 117, during at least one of the manufacture, assembly or use of the battery module 101. In some embodiments, the nonconductive layer 115 is omitted and the current collector assembly 113 may only include one or more busbars 117.

As shown, the battery module 101 includes a carrier layer 119 adjacent to the current collector assembly 113 and the plurality of battery cells 103. In some embodiments, the carrier layer 119 may be a clear plastic, such as clear polycarbonate, clear acrylic, clear PET (polyethylene terephthalate), or any other appropriate translucent material. A clear plastic carrier layer may be used to enable the usage of a UV-cure adhesive that can be exposed to UV light through the clear plastic carrier layer. For example, the plurality of battery cells 103 may be coupled to the carrier layer 119 with the UV-cure adhesive (or another coupling element). UV-cure adhesives may be advantageous due to their long tack-free times and selectively rapid cure times.

The battery module 101 may further include a thermal transfer plate, e.g., a cooling plate 121, as shown. In some embodiments, the thermal transfer plate may be used to selectively heat or cool the battery module 101. The cooling plate 121 may have a cooling fluid port 123, as shown, where the cooling plate 121 either receives or outputs cooling fluid. In some embodiments, there may be a thermal interface material 125 that thermally and structurally couples the second end 107 of each of the plurality of battery cells 103 to the cooling plate 121, maintaining the spatial positioning of the second ends 107 of the battery cells 103 on the cooling plate 121 during operation of the battery module 103, e.g., without the use of a separate carrier layer at the second ends 107 of the battery cells 103. In some embodiments, the thermal interface material 125 may be an adhesive. It may be advantageous to minimize the thickness of the thermal interface material 125 for space-saving purposes. It may also be advantageous to minimize the thickness of the thermal interface material 125 to increase the cooling effect from the cooling plate 121 on the ends 107 of the battery cells 103. However, the thermal interface material 125 should be thick enough to account for worst-case tolerance stack-up, high voltage isolation requirements, and electrical or thermal insulation requirements of the battery module 101.

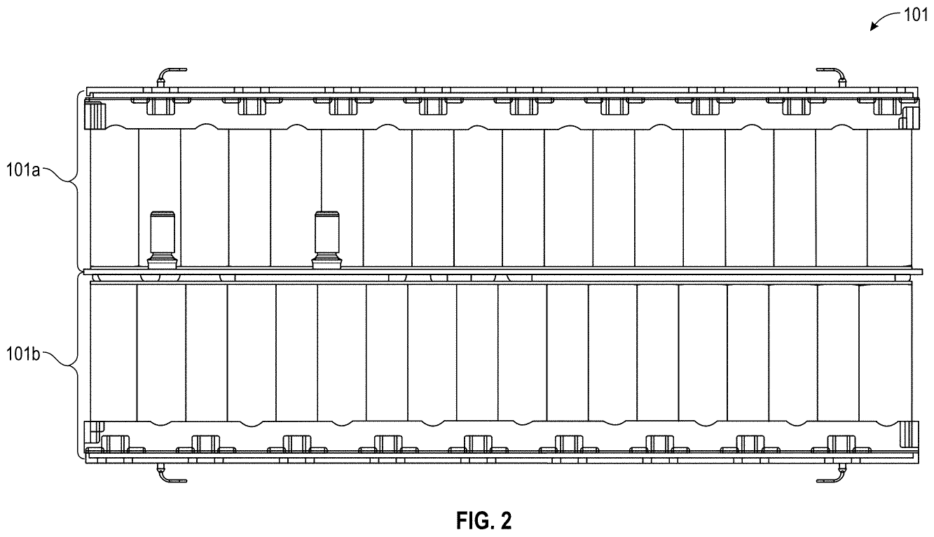

In some embodiments, the components described above in relation to FIG. 1 may form a first battery submodule 101a. FIG. 2 shows a cross-sectional view of a battery module 101 including the first battery submodule 101a and a second battery submodule 101b substantially similar to the first battery submodule 101a. The second battery submodule 101b may be assembled from a second current collector 113 assembly that includes a nonconductive layer 115 and at least one busbar 117, a second carrier layer 119, a second plurality of battery cells 103, and a second thermal interface material 125, where the second thermal interface material 125 couples the second plurality of battery cells 103 to a side of the cooling plate 121 that is opposite to the side of the cooling plate 121 that the first plurality of battery cells 103 are coupled to. In some embodiments, each of the first and second pluralities of battery cells 103 may be coupled to first and second cooling plates 121 respectively, the first and second cooling plates 121 being configured to be joined to each other resulting in a battery module configuration similar to that shown in FIG. 2.

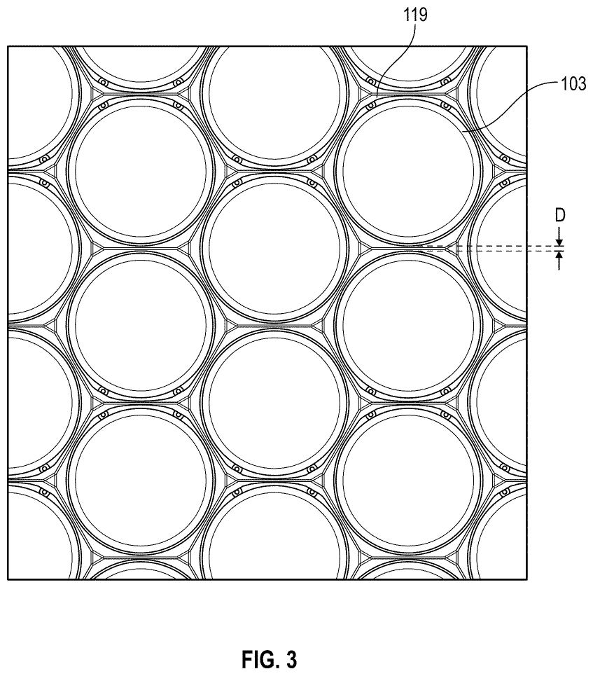

FIG. 3 shows a partial top view of a group of battery cells 103 packaged in a close hexagonal pack configuration in the carrier layer 119, in accordance with some embodiments of the disclosure. Limiting the distance D between each battery cell 103 to less than approximately 1.5 millimeters may be advantageous for space-saving purposes. As shown, the minimum distance D between each cell may be 1.25 millimeters. The carrier layer 119 may provide nonconductive insulation that prevents the battery cells 103 from touching each other, which could result in short circuiting or thermal runaway.

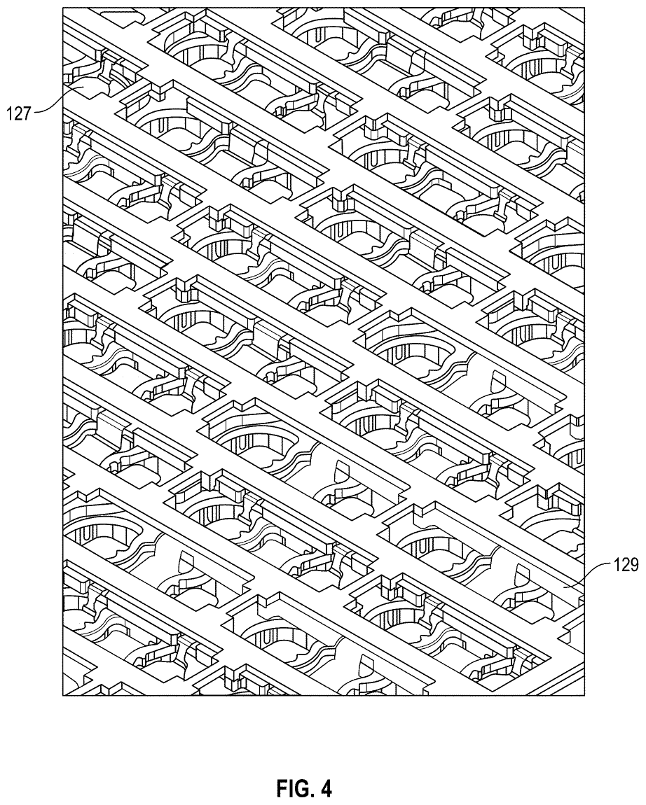

FIG. 4 shows a partial top view of a battery module in accordance with some embodiments of the disclosure. As shown, the battery module may include a current collector assembly includes a non-conductive element and conductive busbars. The non-conductive element may, for example, provide the busbars with structural support and enable handling of the battery module. A first busbar 127 may be electrically coupled (e.g., via welding) to a battery terminal of each battery cell within a group of battery cells. A second busbar 129 may be electrically coupled to the other battery terminal (e.g., through an exposed region of an electrically-active casing or conductive jacket) of each of the group of battery cells. In some embodiments, each busbar 127, 129 may be approximately 2 millimeters in thickness and approximately 350 millimeters in length.

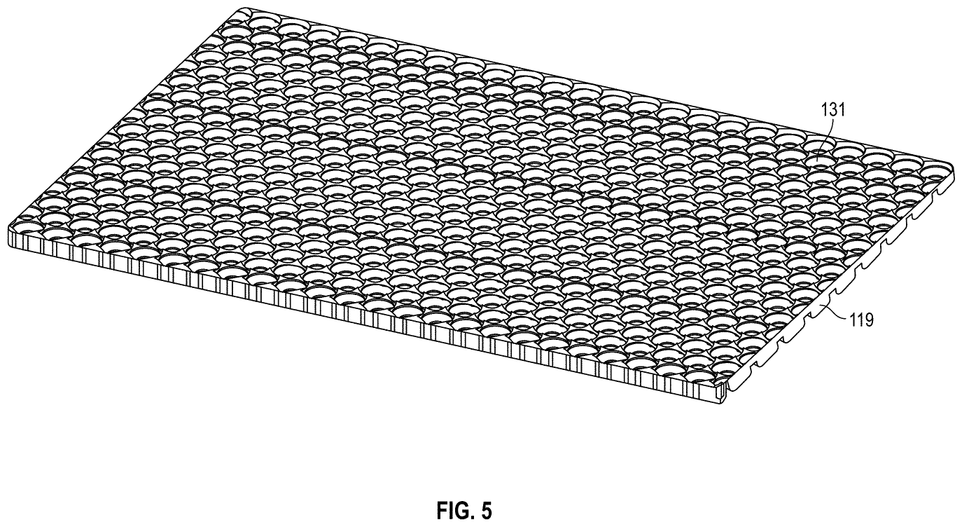

FIGS. 5-12 show a series of steps in a process for assembling a battery module 101 in accordance with some embodiments of the present disclosure. Each of the battery module components used in assembling the battery module 101 and described in the present disclosure may be provided by manufacturing or assembling the component itself, or obtaining the component from a supply of components. FIG. 5 shows a carrier layer 119 in a first orientation, where the carrier layer 119 has multiple recesses 131 that are each configured to receive an end of a cylindrical battery cell. In some embodiments, the recesses 131 may be positioned in a close hexagonal packing configuration. The recesses 131 may enable at least one electrical terminal on the end of the battery cell, e.g., the first end 105 of the battery cell, to be electrically coupled with another element. In some embodiments, an adhesive may be applied to one or more of the recesses 131. The amount of adhesive applied to each recess 131 may vary between each recess 131. In some embodiments, one or more of the recesses 131 may not have adhesive applied. In some embodiments, the carrier layer 119 may be a clear plastic material, and the adhesive applied to the recesses 131 may be a UV-cure adhesive.

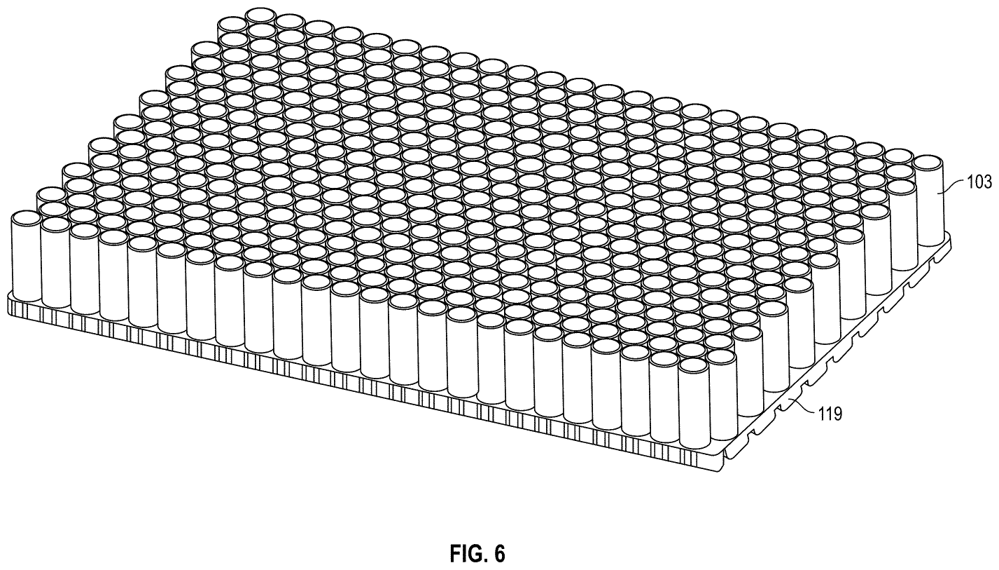

FIG. 6 shows the battery module assembly of FIG. 5 following insertion of a plurality of battery cells 103 into the recesses of the carrier layer 119. In some embodiments, an adhesive may be applied to the ends, e.g., the first ends, of the battery cells 103 before they are coupled to the recesses 131 of the carrier layer 119. Following the insertion of the battery cells 103, a nonconductive pin platform (not shown) may be applied to the ends, e.g., the second ends, of the battery cells 103 that are not coupled to the carrier layer 119. The pin platform may include a generally rectangular shape with protruding pins positioned to partially fill gaps between the battery cells 103. The pin platform may prevent the battery cells 103 from touching each other, particularly in the event that the carrier layer 119 and battery cells 103 are moved from a first orientation to a second orientation. The pin platform may be releasably securable to the battery cells 103, e.g., by virtue of an interference fit coupling. In some embodiments, the pin platform may be a material of approximately 60% glass-filled polypropylene. In some embodiment, a material for the pin platform may be selected based on one or more of the following properties: rigidity, durability, and low surface energy (i.e., to keep module adhesives from adhering).

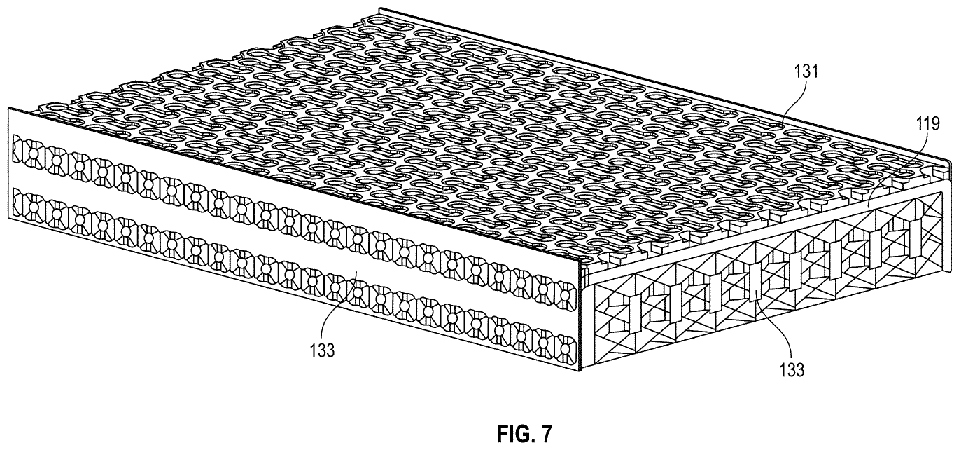

FIG. 7 shows the battery module assembly of FIG. 6 after it has been moved from a first orientation (FIG. 6) to a second orientation as shown. In some embodiments, in the second orientation, the carrier layer 119 may be upside-down relative to the position of the carrier layer 119 in the first orientation. As shown, side walls 133 have been added to the battery module assembly, resulting in the plurality of battery cells 103 being encased on at least five sides of the generally rectangular prismatic shape of the battery module 101 (i.e., by the carrier layer 119 on one side, and by the side walls 133 on four sides). In some embodiments, the side walls 133 may be a translucent material, e.g., a clear plastic material. The pin platform described above may be on a bottom side of the incomplete battery module 101 (not shown).

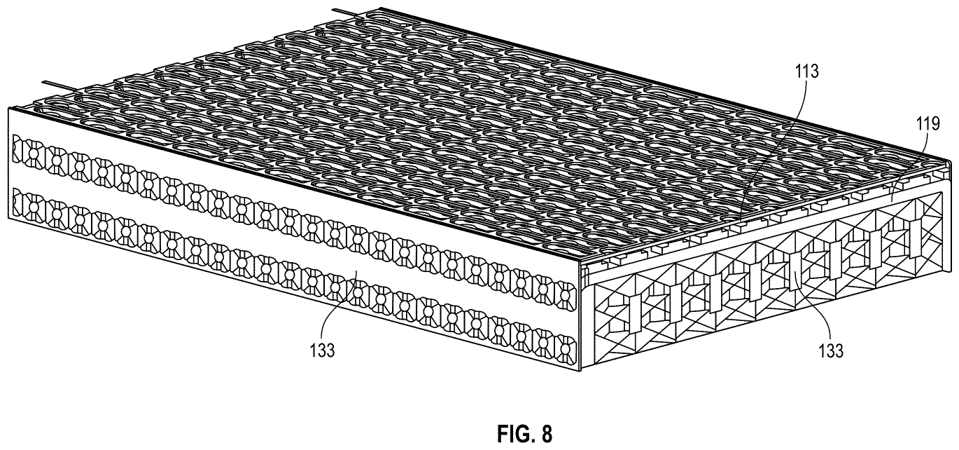

FIG. 8 shows the battery module assembly of FIG. 7 following installation of a current collector assembly 113. In some embodiments, the current collector assembly 113 may include the nonconductive element and conductive busbars, as described above in relation to FIG. 4. The current collector assembly 113 may be installed by physically coupling portions of the current collector assembly 113 with the carrier layer 119 and electrically coupling portions of each busbar in the current collector assembly 113 to a group of the plurality of battery cells 103 in the battery module 101. In some embodiments, an adhesive may be applied to the current collector assembly 113 before it is installed. In some embodiments, installing the current collector assembly 113 may involve welding tabs of the current collector assembly 113 to at least some of the plurality of battery cells 103. Following the installation of the current collector assembly 113, the battery module 101 of FIG. 8 may be moved from its current orientation (i.e., the second orientation shown in FIGS. 7-8) to a different orientation (e.g., back to the first orientation as shown in FIGS. 5-6). In some embodiments, this may involve “flipping” the battery module 101 upside-down. Following moving the battery module 101 from the second to the first orientation, the pin platform may be removed from a top surface of the battery module 101.

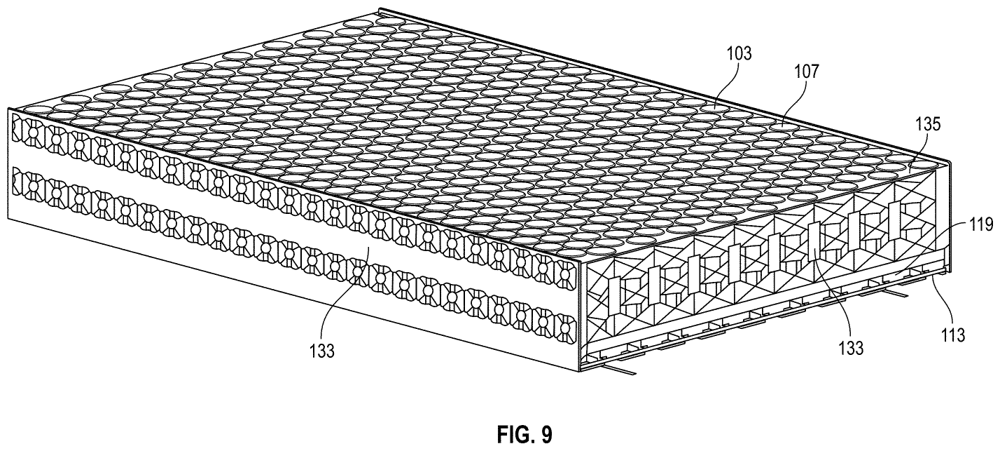

FIG. 9 shows the battery module assembly of FIG. 8 following moving the battery module 101 from the second orientation back to the first orientation (i.e., resulting in the current collector assembly 113 being at a bottom surface of the battery module 101) and removing the pin platform (i.e., from a top surface of the battery module as shown in FIG. 9). As shown, an end, e.g., a second end 107, of each of the battery cells 103 is accessible at a top surface 135 of the battery module 101. In some embodiments, a thermal interface material (e.g., an adhesive) may be applied to the accessible ends 107 of the battery cells 103.

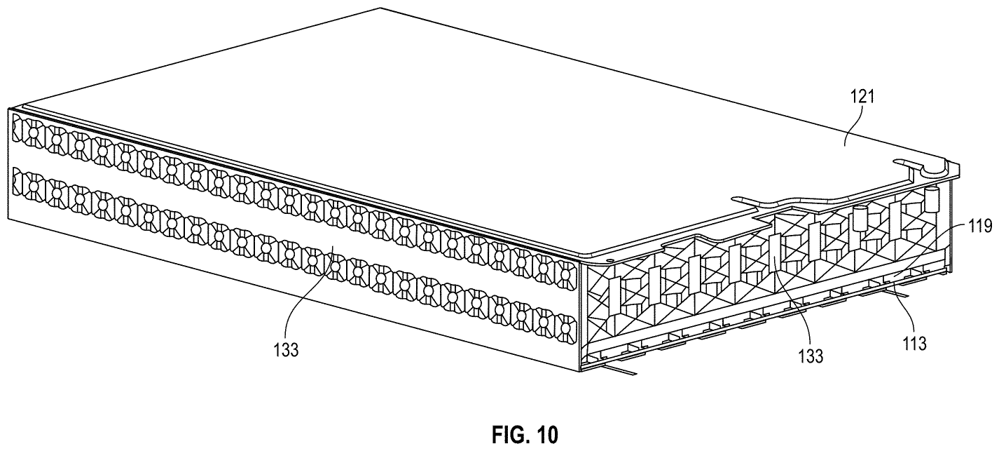

FIG. 10 shows the battery module assembly of FIG. 9 following installation of a cooling plate 121. In some embodiments, the cooling plate 121 may be coupled to the exposed ends 107 of the battery cells in FIG. 9 after the thermal interface material has been applied.

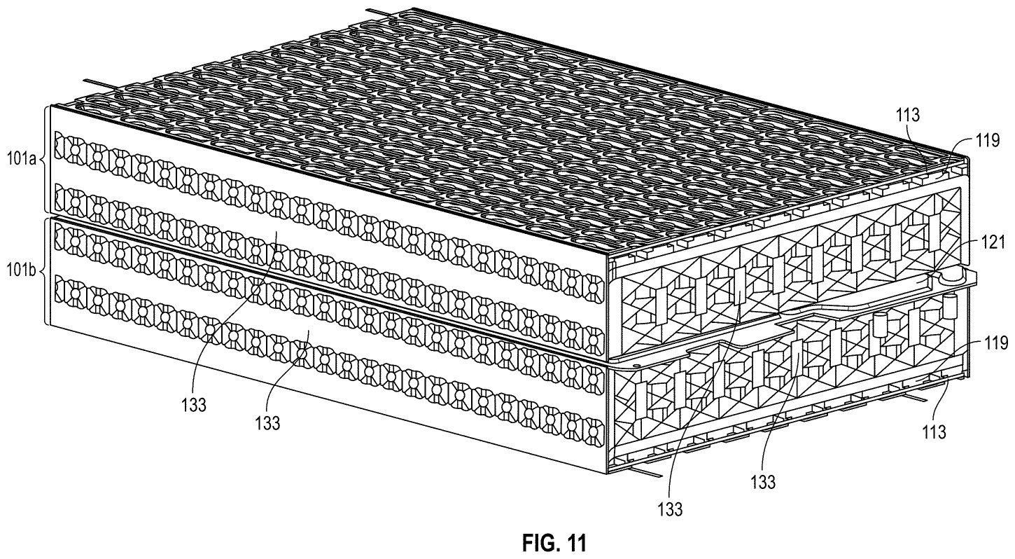

In some embodiments, and as described above in relation to FIG. 2, two modules 101a, 101b of battery cells 103 may be coupled on opposite sides of the cooling plate 121 to form a larger battery module 101, where each of the two smaller modules 101a, 101b includes at least one busbar, a carrier layer, and a plurality of battery cells 103. FIG. 11 shows a battery module 101 made up of two submodules 101a, 101b coupled to opposite sides of the cooling plate 121, in accordance with some embodiments of the disclosure. For example, the battery module 101 shown in FIG. 10 may be the bottom submodule 101b of FIG. 11. It will be understood that a battery submodule 101a, 101b in accordance with the present disclosure may or may not include a cooling plate 121. That is, the term “submodule” may refer both to a battery module 101 as described above with or without a cooling plate component.

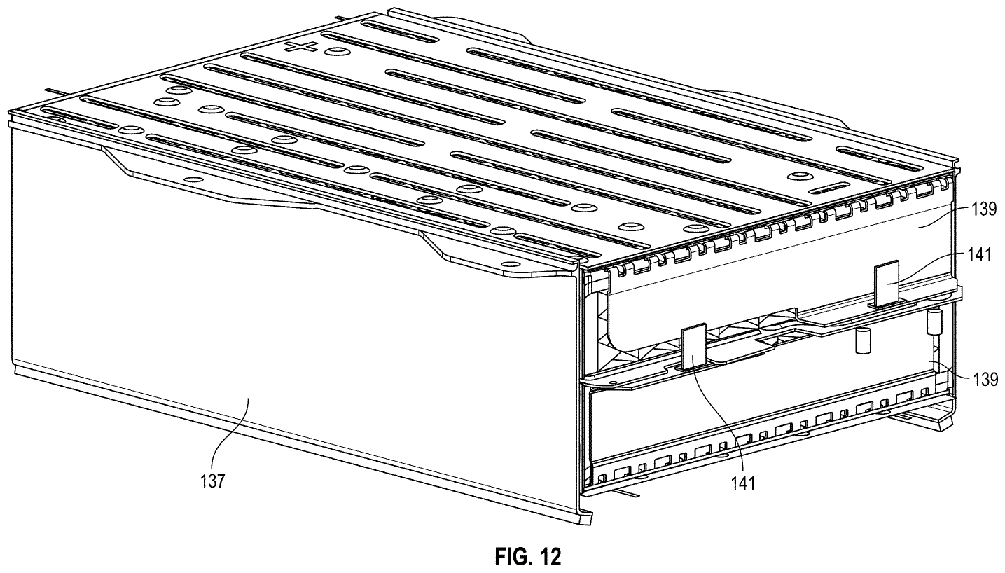

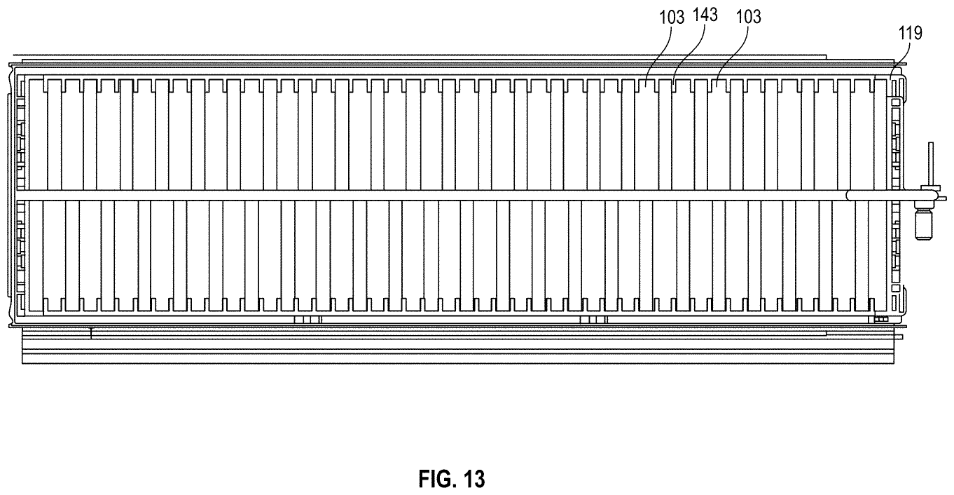

FIG. 12 shows the battery module 101 of FIG. 11 following the installation of additional battery module elements, such as side shear walls 137, terminal busbars 139, and terminal interface elements 141, as shown. In some embodiments, the terminal busbars 139 convey current from busbars 117 in the current collector assemblies 113 (on both the top and bottom of the battery module 101) to the terminal interface elements 141, which may be configured to be electrically coupled to a conductor external to the battery module 101. FIG. 13 shows a cross-sectional view of the battery module 101 of FIG. 12. As shown, the carrier layer 119 may have protruding elements 143 separating the battery cells 103 within the battery module 101.

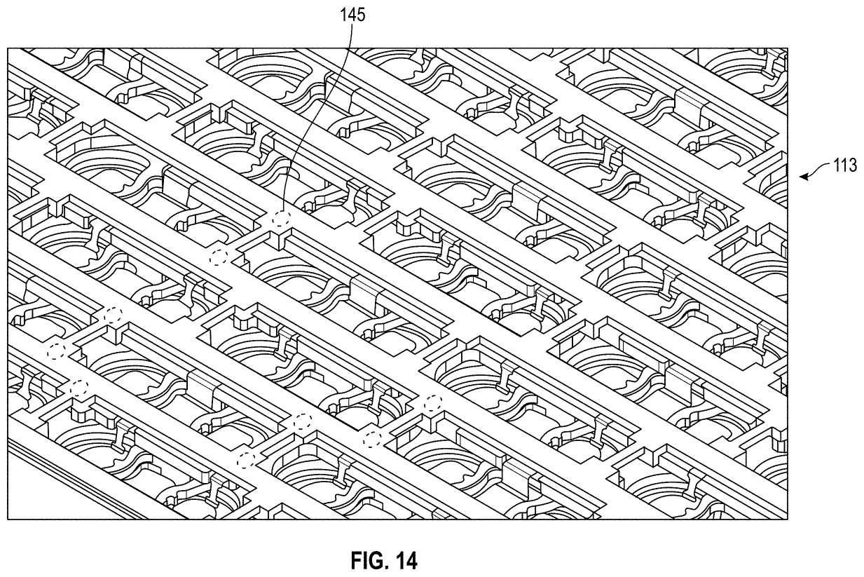

In accordance with some embodiments of the present disclosure, a battery module 101, a submodule 101a, 101b, or a partially assembled battery module (e.g., as shown in FIGS. 5 to 12) may be handled by applying force to the current collector assembly 113. In some embodiments, the battery module 101 may be lifted or moved by applying suction (e.g., through vacuum cups) to portions of the current collector assembly 113. FIG. 14 shows a partial view of a current collector assembly 113 of the battery module 101, where exemplary vacuum points 145 are shown using dotted circles. In some embodiments, approximately 70 kilopascals of pressure may need to be applied at each vacuum point, depending on the configuration of the battery module 101.

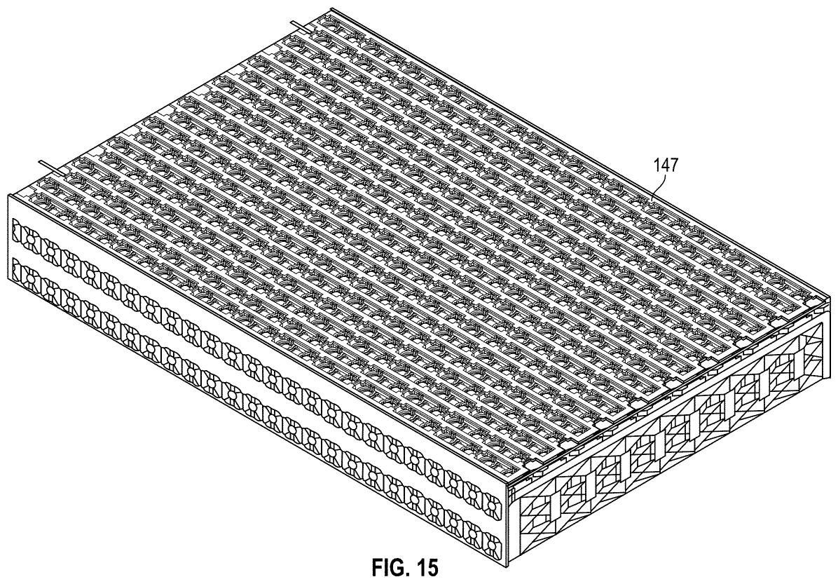

In some embodiments, the battery module 101 may be handled by applying an electroadhesive grip to the current collector assembly 113. At least a portion of surface 147 of the battery module 101 of FIG. 15 may be where the electroadhesive grip is applied. In other embodiments, the battery module 101 may be handled by sealing gaps of the current collector assembly surface and maintaining vacuums at approximately 7 kilopascals in each of the cavities in the current collector assembly 113. At least a portion of surface 147 of the battery module 101 of FIG. 15 may be where the surface is sealed.

FIG. 16 shows a partial top view of a current collector assembly 113 and two battery cells 103. In some embodiments, the battery module 101 may comprise cavities 149 through which air can pass. The cavities 149 have, in combination, approximately 0.2 millimeters of hydraulic diameter effect per cavity 149, which means that some airflow will occur when the cavities 149 are under vacuum pressure.

The foregoing is merely illustrative of the principles of this disclosure, and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

1. A battery module comprising:
a first current collector assembly;
a first carrier layer;
a first plurality of battery cells, wherein a first terminal of each of the first plurality of battery cells is electrically coupled to a busbar of the first current collector assembly, wherein a first end of each of the first plurality of battery cells is physically coupled to the first carrier layer, and wherein at least a portion of the first carrier layer is positioned between the first current collector assembly and the first plurality of battery cells;
a cold plate; and
a first thermal interface material thermally and structurally coupling a second end of each of the first plurality of battery cells to the cold plate, wherein the first thermal interface material maintains the spatial positioning of the second ends of the first plurality of battery cells on the cold plate during operation without the use of a separate carrier support structure at the second ends of the first plurality of battery cells.

2. The battery module of claim 1, further comprising:
a second current collector assembly;
a second carrier layer;
a second plurality of battery cells, wherein a first terminal of each of the second plurality of battery cells is electrically coupled to a busbar of the second current collector assembly, wherein a first end of each of the second plurality of battery cells is physically coupled to the second carrier layer, and wherein at least a portion of the second carrier layer is positioned between the first current collector assembly and the second plurality of battery cells; and
a second thermal interface material thermally and structurally coupling a second end of each of the second plurality of battery cells to an opposite side of the cold plate, wherein the second thermal interface material maintains the spatial positioning of the second ends of the second plurality of battery cells on the opposite side of the cold plate during operation without the use of a separate carrier support structure at the second ends of the second plurality of battery cells.

3. The battery module of claim 1, wherein the first carrier layer comprises a plurality of recesses, and wherein the first end of each of the first plurality of battery cells is physically coupled to the first carrier layer by being inserted into a respective recess of the plurality of recesses.

4. The battery module of claim 1, wherein the first carrier layer comprises a clear plastic material.

5. The battery module of claim 4, further comprising a UV-curing adhesive, wherein the first end of each of the first plurality of battery cells is physically coupled to the first carrier layer with the UV-curing adhesive.

6. The battery module of claim 1, wherein the first plurality of battery cells is in a close-hex-pack configuration, and wherein each of the first plurality of battery cells is less than 1.5 millimeters apart.

7. The battery module of claim 1, wherein the first thermal interface material comprises a tensile strength of at least 5 megapascals.

8. The battery module of claim 1, wherein the first thermal interface material comprises a T-peel strength of at least 7 Newtons per millimeter.

9. The battery module of claim 1, wherein the first thermal interface material comprises a Young's Modulus value of at least 50 megapascals.

10. The battery module of claim 1, wherein each of the first plurality of battery cells comprises an exposed region of electrically-active casing that covers the first end and the side of the battery cell.

11. The battery module of claim 1, wherein:
the first current collector assembly comprises at least five busbars; and
the first plurality of battery cells comprises at least 200 battery cells;
wherein the at least five busbars electrically couple the first plurality of battery cell in parallel and in series.

12. A method of assembling a battery module, the method comprising:
providing a first current collector assembly, a first carrier layer, a first plurality of battery cells, a first thermal interface material, and a cold plate, wherein the first carrier layer comprises a first plurality of recesses, each configured to receive an end of a battery cell;
selectively applying an adhesive to each of the first plurality of recesses in the first carrier layer with the first carrier layer in a first position;
inserting each of the first plurality of battery cells into a respective recess with the first carrier layer in the first position, wherein a first end of each of the first plurality of battery cells is thereby coupled to a respective recess of the first carrier layer;
moving the first carrier layer with the inserted battery cells into a second position;
positioning the first current collector assembly adjacent to the first carrier layer;
in the second position, electrically coupling each of the first plurality of battery cells to a busbar of the first current collector assembly;
moving the first plurality of battery cells, the first carrier layer, and the first current collector assembly to the first position;
applying the first thermal interface material to a second end of each of the first plurality of battery cells; and
coupling the cold plate to the second ends of the first plurality of battery cells with the applied first thermal interface material, wherein the first thermal interface material maintains the spatial positioning of the second ends of the first plurality of battery cells on the cold plate during operation.

13. The method of claim 12, further comprising:
providing a second current collector assembly, a second carrier layer, a second plurality of battery cells, and a second thermal interface material, wherein the second carrier layer comprises a second plurality of recesses, each configured to receive an end of a battery cell;
applying an adhesive to each of the second plurality of recesses in the second carrier layer with the second carrier layer in the first position;
inserting each of the second plurality of battery cells into a respective recess with the second carrier layer in the first position, wherein a first end of each of the second plurality of battery cells is thereby coupled to a respective recess of the second carrier layer;
moving the second carrier layer with the inserted battery cells into the second position;
positioning the second current collector assembly adjacent to the second carrier layer;
in the second position, electrically coupling each of the second plurality of battery cells to a busbar of the second current collector assembly;
moving the second plurality of battery cells, the second carrier layer, and the second current collector assembly to the first position;
applying the second thermal interface material to a second end of each of the second plurality of battery cells; and
coupling an opposite surface of the cold plate to the second ends of the second plurality of battery cells with the applied second thermal interface material, wherein the second thermal interface material maintains the spatial positioning of the second ends of the second plurality of battery cells on the cold plate during operation.

14. The method of claim 12, further comprising:
providing a pin platform, wherein the pin platform comprises a generally rectangular form with protruding pins configured to prevent close-packed battery cells from touching each other; and
wherein moving the first carrier layer with the inserted battery cells into the second position comprises:
applying the pin platform to the second ends of the first plurality of battery cells; and
moving the first plurality of battery cells, the first carrier layer, and the applied pin platform to the second position.

15. The method of claim 14, wherein moving the first plurality of battery cells, the first carrier layer, and the first current collector assembly to the first position comprises:
moving the applied pin platform with the first plurality of battery cells, the first carrier layer, and the first current collector assembly to the first position; and
removing the pin platform.

16. The method of claim 12, wherein the first plurality of battery cells is positioned in a close-hex-pack configuration in the first carrier layer, and wherein each of the first plurality of battery cells is less than 1.5 millimeters apart.

17. The method of claim 12, wherein the adhesive applied to each of the first plurality of recesses in the first carrier layer is a UV-curing adhesive.

18. The method of claim 17, further comprising exposing the UV-curing adhesive to a UV light source.

19. The method of claim 12, further comprising moving the assembled battery module by applying vacuum cups to a plurality of points on the first current collector assembly.

20. The method of claim 12, further comprising moving the assembled battery module by at least one of:
applying an electroadhesive grip to at least a portion of the first current collector assembly; and
by sealing a surface of the first busbar and maintaining a vacuum in at least one cavity of the first current collector assembly.
